(19) United States
(12) Patent Application Publication
(10) Pub. No.: US 2014/0157785 A1
(43) Pub. Date: Jun. 12, 2014

(54) FUEL SUPPLY SYSTEM FOR GAS TURBINE

(71) Applicant: GENERAL ELECTRIC COMPANY, Schenectady, NY (US)

(72) Inventors: Mahesh Bathina, Bangalore (IN); Madanmohan Manoharan, Bangalore (IN)

(73) Assignee: GENERAL ELECTRIC COMPANY, Schenectady, NY (US)

(21) Appl. No.: 13/707,516

(22) Filed: Dec. 6, 2012

(51) Int. Cl. F02C 9/40

(52) U.S. Cl. CPC F02C 9/40
USPC 60/772; 60/734; 60/737

(57) ABSTRACT

A system includes a fuel supply system. The fuel supply includes a primary fuel supply, a fuel additive supply, and a common pipeline coupled to the primary fuel and fuel additive supplies. The primary fuel supply includes a primary fuel having a first average molecular weight. The fuel additive includes a fuel additive having a second molecular weight that is greater than the first average molecular weight. The common pipeline is configured to direct a mixture of the primary fuel and the fuel additive into a fuel nozzle.

### BACKGROUND OF THE INVENTION

The subject matter disclosed herein relates to gas turbines, and more specifically, to systems and methods for controlling fuel flow in fuel nozzles.

Gas turbine systems generally include a compressor, a combustor, and a turbine. The compressor compresses air from an air intake, and subsequently directs the compressed air to the combustor. In the combustor, the compressed air received from the compressor is mixed with a fuel and is combusted to create combustion gases. The combustion gases are directed into the turbine. In the turbine, the combustion gases pass across turbine blades of the turbine, thereby driving the turbine blades, and a shaft to which the turbine blades are attached, into rotation. The rotation of the shaft may further drive a load, such as an electrical generator, that is coupled to the shaft.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In one embodiment, a system includes a fuel supply system. The fuel supply includes a primary fuel supply, a fuel additive supply, and a common pipeline coupled to the primary fuel and fuel additive supplies. The primary fuel supply includes a primary fuel having a first average molecular weight. The fuel additive includes a fuel additive having a second molecular weight that is greater than the first average molecular weight. The common pipeline is configured to direct a mixture of the primary fuel and the fuel additive into a fuel nozzle.

In a second embodiment, a gas turbine engine includes a compressor, a combustor, a fuel supply system, and a turbine. The compressor is configured to compress air. The combustor comprises at least one fuel nozzle and is configured to receive the air from the compressor and to combust the air and a fuel mixture to generate combustion products. The fuel supply system is configured to supply the fuel mixture to the at least one fuel nozzle. The fuel supply system includes a primary fuel supply, a fuel additive supply, and a common pipeline coupled to the primary fuel supply and the fuel additive supply. The primary fuel supply includes a primary fuel having a first average volumetric heating value. The fuel additive includes a fuel additive having a second average volumetric heating value that is greater than the first average volumetric heating value. The common pipeline is configured to mix the primary fuel and the fuel additive to form the fuel mixture and to direct the fuel mixture to the combustor. The turbine is configured to receive the combustion products from the combustor.

In a third embodiment, a method includes detecting an operating parameter related to combustion of air and a fuel mixture within a combustor, determining if the operating parameter is desirable using a sensor and a controller, and adjusting a flow rate of a fuel additive based on a measurement of the operating parameter. The fuel additive has a first volumetric heating value that is greater than an overall volumetric heating value of the fuel mixture. The fuel mixture includes a primary fuel and a fuel additive.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic diagram of an embodiment of a gas turbine system having a fuel supply system with features to improve flame stability;

FIG. 2 is a perspective view of an embodiment of fuel nozzles of the fuel supply system, illustrating an arrangement of the fuel nozzles within a combustor of the gas turbine system;

FIG. 3 is a block diagram of an embodiment of the fuel supply system of FIG. 1, illustrating a fuel additive supply containing higher hydrocarbons (HHCs) and/or diluents to improve flame stability within the combustor;

FIG. 4 is a partial cross-sectional view of an embodiment of the fuel nozzle of FIG. 1 with a plurality of swirl vanes to mix fuel and air for delivery into the combustor;

FIG. 5 is a perspective view of an embodiment of the swirl vane of FIG. 4; and

FIG. 6 is a partial cross-sectional view of an embodiment of the fuel nozzle of FIG. 1 with a plurality of pilot tubes configured to mix fuel and air for delivery into the combustor.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

By way of introduction, a distinction should be drawn between the terms “energy output” and “energy density”. The term “energy output” may refer to a rate of energy produced by combustion of a fuel. Accordingly, the energy output of a system may be increased by increasing a flow rate of the fuel. On the other hand, the terms “energy density” and “heating value” refer to intensive properties of the fuel. The energy density may be volumetric (i.e., energy produced per unit volume), molar (i.e., energy produced per mole of substance), or have another suitable basis. Notably, changing the flow rate of the fuel may have no impact on its energy density.

The present disclosure is directed toward systems and methods to improve flame stability within combustors of gas turbine systems. In particular, a fuel additive may be added to a primary fuel to form a fuel mixture, and the fuel mixture may then be directed to the combustor for combustion. The composition of the fuel mixture may be varied in order to adjust certain properties (e.g., energy density or heating value) of the fuel, which, in turn, may adjust the pressure, temperature, length, volume, flame front shape, or another parameter of the combustion flame. In certain embodiments, the fuel additive includes a higher hydrocarbon (HHC) with a higher molecular weight, density, and/or volumetric energy density than the primary fuel. For example, the primary fuel may be mostly methane, and the fuel additive may include ethane, propane, or butane.

As will be appreciated, the primary fuel is often a mixture of several components, such as hydrocarbons (e.g., alkanes), sulfur (e.g., thiols), and/or nitrogen (e.g., amines). These components define average properties (e.g., molecular weight, energy density, etc.) of the primary fuel. The primary fuel is typically not homogenous, and the average properties may change over time, often unpredictably. Unfortunately, these unpredictable changes result in combustion instabilities within the gas turbine system. For example, the energy density (e.g., heating value) of the primary fuel may decrease, resulting in fluctuations in flame temperature, flame pressure, and flame volume. Thus, it is now recognized that the addition of a fuel additive may help reduce these fluctuations within the primary fuel. In other words, the fuel additive can help change the average energy density, molecular weight, volumetric flow rate, and other properties of the primary fuel. In this manner, the fuel properties can help stabilize the flame, thereby reducing combustion dynamics and increasing the efficiency of the gas turbine system.

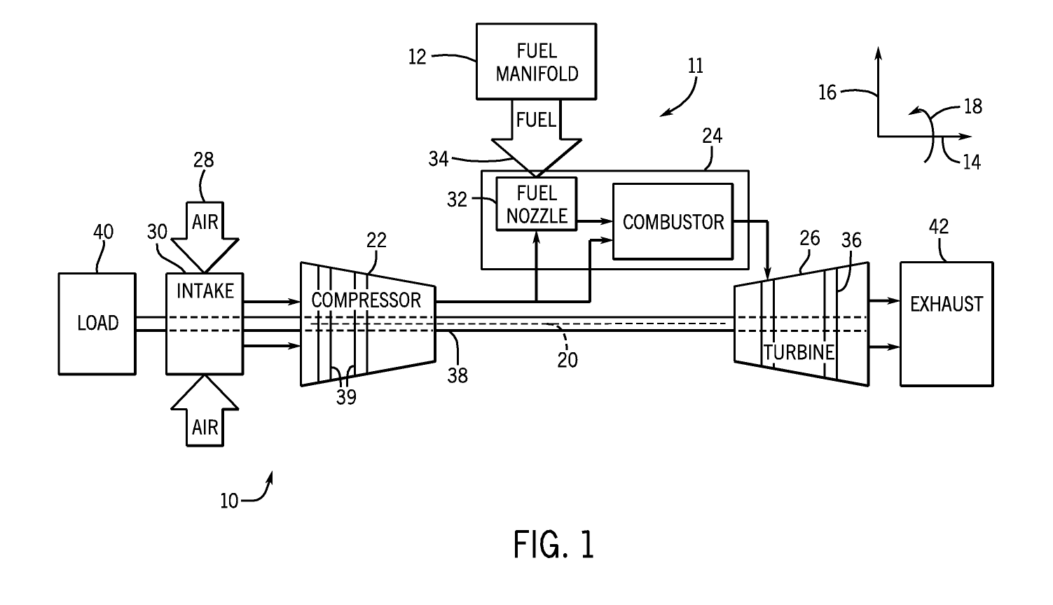

Turning now to the figures, FIG. 1 illustrates a block diagram of an embodiment of a gas turbine system 10 having a fuel supply system 11 with features to improve the operability of the gas turbine system 10. For example, the fuel supply system 11 may supply at least one fuel additive (e.g., one or more HHCs) for stabilizing a flame within the gas turbine system 10. In the illustrated embodiment, the fuel supply system 11 includes a fuel manifold 12, which may route or flow a primary fuel and one or more fuel additives. Throughout the discussion, a set of axes will be referenced. These axes are based on a cylindrical coordinate system and point in an axial direction 14, a radial direction 16, and a circumferential direction 18. For example, the axial direction 14 extends along a longitudinal axis 20 of the gas turbine system 10, the radial direction 16 extends away from the longitudinal axis 20, and the circumferential direction 18 extends around the longitudinal axis 20.

As illustrated, the gas turbine system 10 includes a compressor 22, a combustor 24, and a turbine 26. The compressor 22 receives air 28 from an intake 30 and compresses the air 28 for delivery to the combustor 24. A portion of the air 28 is routed to a fuel nozzle 32, where the air 28 may premix with a fuel (e.g., a fuel mixture) 34 before entering the combustion zone. As shown, the fuel 34 is supplied by the fuel manifold 12. The fuel manifold 12 may also supply a fuel additive (e.g., one or more HHCs) to adjust the composition of the fuel 34. As noted earlier, the composition of the fuel 34 may be adjusted in order to improve the stability of the flame within the combustor 24.

The air 28 and the fuel 34 are fed to the combustor 24 at a ratio suitable for combustion, emissions, power output, and the like. The mixture of the air 28 and the fuel mixture 34 is subsequently combusted in the combustor 24, thereby producing hot combustion products. The hot combustion products enter the turbine 26 and force blades 36 of the turbine 26 to rotate, thereby driving a shaft 38 of the gas turbine system 10 into rotation. The rotating shaft 38 provides the energy for the compressor 22 to compress the air 28. More specifically, the rotating shaft 38 further rotates compressor blades 39 attached to the shaft 38 within the compressor 22, thereby compressing the air 28 that is fed into the compressor 22. In addition, the rotating shaft 38 may rotate a load 40, such as an electrical generator or any device capable of utilizing the mechanical energy of the shaft 38. After the turbine 26 extracts useful work from the combustion products, the combustion products are discharged to an exhaust 42.

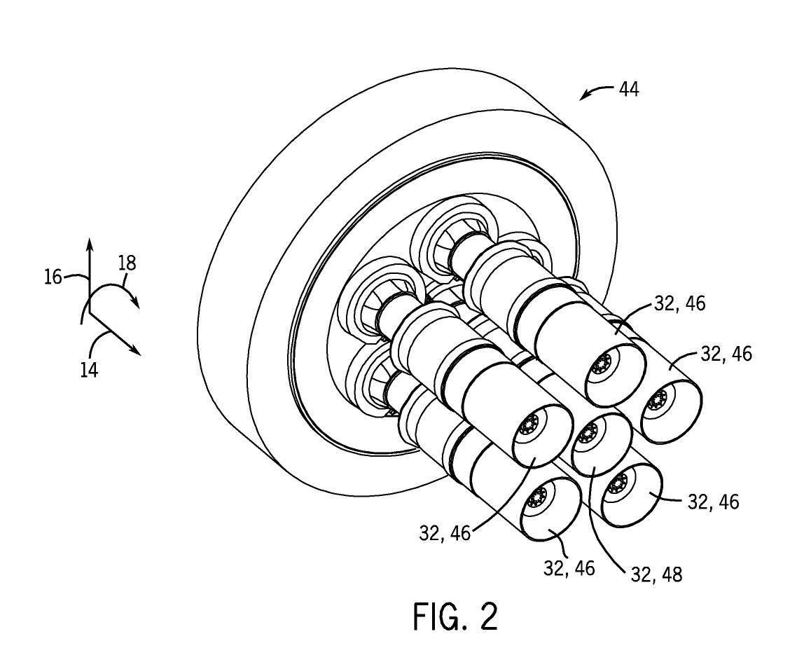

As noted previously, the fuel supply system 11 supplies a fuel additive to one or more fuel nozzles 32 in order to improve combustion stability. FIG. 2 illustrates an arrangement of the fuel nozzles 32 within the combustor 24 of the gas turbine system 10. As shown, six fuel nozzles 32 are mounted to a head end 44 of the combustor 24. However, in other embodiments, the number of fuel nozzles 32 may vary. For example, the gas turbine system 10 may include 1, 2, 3, 4, 5, 10, 50, 100, or more fuel nozzles 32.

As illustrated, the six fuel nozzles 32 are disposed in a concentric arrangement. That is, five fuel nozzles 32 (e.g., outer fuel nozzles 46) are disposed about a central fuel nozzle 48. As will be appreciated, the arrangement of the fuel nozzles 32 on the head end 44 may vary. For example, the fuel nozzles 32 may be disposed in a circular arrangement, in a linear arrangement, or in any other suitable arrangement.

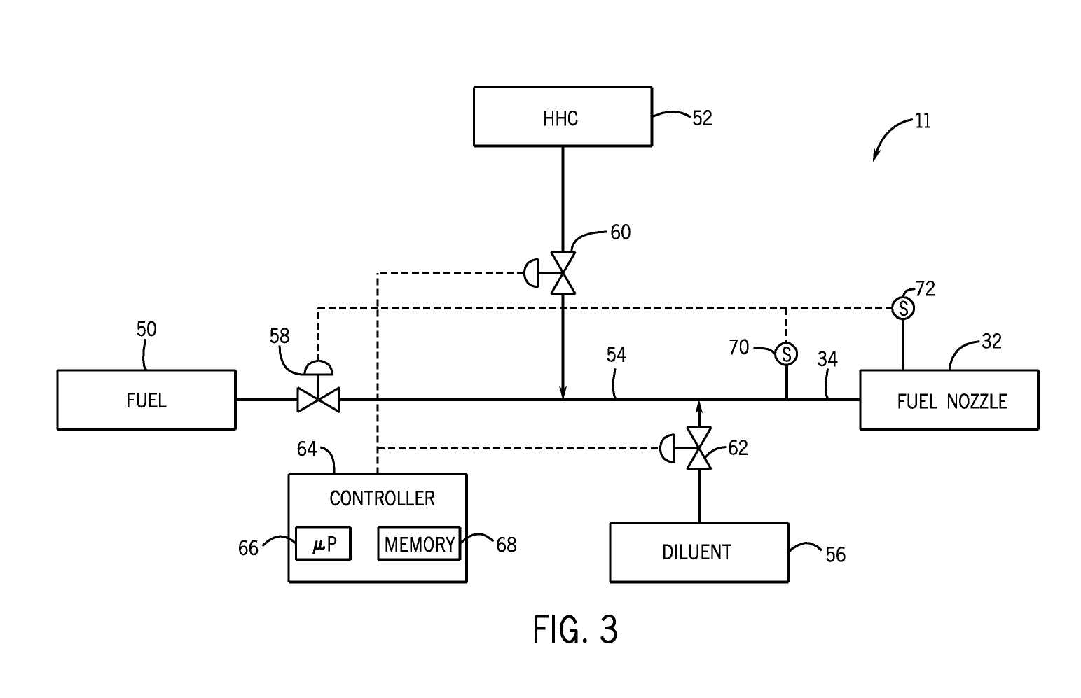

In certain embodiments, the fuel supply system 11 may supply the fuel additive to a certain subset of the fuel nozzles 32. For example, the central fuel nozzle 48 (e.g., pilot fuel nozzle) generally may have a greater influence on combustion dynamics, and it may be desirable to supply the fuel additive to the central fuel nozzle 48. However, certain embodiments of the fuel supply system 11 may supply the fuel additive to all of the fuel nozzles 32. In addition, the fuel supply system 11 may supply a similar or different HHC to each of the fuel nozzles 32. The components of the fuel supply system 11 are discussed below with respect to FIG. 3.

FIG. 3 illustrates a block diagram of an embodiment of the fuel supply system 11. The fuel supply system 11 includes a primary fuel supply 50 and a fuel additive (e.g., HHC) supply 52 coupled together by a common pipe 54. That is, the primary fuel 50 and the HHC 52 combine to form the fuel mixture 34 that is directed to the fuel nozzles 32. The HHC 52 may be supplied from storage tanks coupled to the fuel supply system 11. As noted earlier, the fuel additive 52 may be any fuel having a greater molecular weight, density, and/or energy density than the primary fuel 50. For example, the primary fuel 50 may include methane, and the HHC 52 may include ethane, propane, butane, another alkane, an alkene, alkyne, or any other suitable hydrocarbon. It should be noted that the HHC 52 is often a mixture of various components, and may include hydrocarbons, thiols, amines, and the like. In certain embodiments, the HHC 52 may include any species with more than one carbon molecule (e.g., C₁+). The HHC 52 may have at least, on average, 1, 2, 3, 4, 5, or more carbon atoms per molecule than the primary fuel 50. Certain HHCs 52 have a higher heating value (HHV) in the range of 1500 to 11000 BTU/cubic foot.

The combustor 24 may be designed to combust the fuel mixture 34 to produce a specific total energy output. As noted earlier, the energy density of the primary fuel 50 may vary, which results in a variable total energy output. In order to stabilize and maintain the total energy output, the flow rate and/or the composition of the fuel mixture 34 may be varied. As will be appreciated, stabilization of the energy output may improve the operability and efficiency of the gas turbine system 10.

The flow rate of the fuel mixture 34 can be increased or decreased by adding a diluent 56 and/or the HHC 52 to achieve a desired total heat output. In order to maintain an approximately constant total heat output, the HHC 52 may be used to increase the energy density of the fuel mixture 34, thereby reducing the total flow rate of the fuel mixture 34. Depending on the desired total energy output, the flow rate of the HHC 52 may be less than approximately 40, 30, or 20 percent of the total flow rate of the fuel mixture 34 by volume. However, in certain embodiments, it may be desirable to adjust the total energy output without changing the flow rate of the fuel mixture 34.

In certain embodiments, the fuel nozzle 32 may operate using the primary fuel 50 without the HHC 52 until it is desired to adjust the energy density of the fuel mixture 34. For example, the gas turbine system 10 may include a plurality of operating modes, such as a startup mode, a steady-state mode, a low load mode, a medium load mode, a high load mode, a transient mode, a shut-down mode, or any other mode, each having a controlled ratio of primary fuel 50 to the HHC 52. For example, each of these modes may include a mixture of primary fuel 50 and 1, 2, 3, 4, 5, or more fuel additives 52 (i.e., HHCs). The primary fuel 50 and one or more fuel additives 52 may change for each mode, or they may be partially or entirely the same. Furthermore, the ratio among the primary fuel 50 and one or more fuel additives 52 may change from one mode to another.

It may also be desirable to increase the flow rate of the fuel mixture 34 without changing the total heat output. As shown, a diluent supply 56 is coupled to the common pipe 54. The diluent 56 may be any material having a lower average molecular weight, density, and/or energy density than the primary fuel 50. For example, the diluent may be steam, nitrogen, another inert gas, an alcohol, ketone, or any other suitable material. Thus, the addition of the diluents 56 into the primary fuel 50 decreases the energy density of the fuel mixture 34. In a manner similar to the HHC 52 above, a flow rate of the primary fuel 50 may be decreased and a flow rate of the diluent 56 may be increased by a greater amount that impacts the pressure drop across the fuel nozzle 32.

In order to adjust the flow rates of the primary fuel 50, the HHC 52, and the diluent 56, control valves 58, 60, and 62 are disposed along their respective flow paths. The control valves 58, 60, and 62 are communicatively coupled to a controller 64. As shown, the controller 64 includes a processor 66 and memory 68 to execute instructions to control the combustion dynamics by adjusting the control valves 58, 60, and 62. These instructions may be encoded in software programs that may be executed by the processor 66. Further, the instructions may be stored in a tangible, non-transitory, computer-readable medium, such as the memory 68. The memory 68 may include, for example, random-access memory, read-only memory, hard drives, and the like. In certain embodiments, the controller 64 may execute instructions to control the ratio of the primary fuel 50 to the HHC 52 in each operating mode of the gas turbine system (e.g., startup mode, steady-state mode, etc.)

The combustion dynamics and flame stability are largely affected by the energy output and energy density of the fuel mixture 34. However, the flame stability is affected by a myriad of other operating parameters, such as flame temperature, pressure fluctuations, flow rates, pressure drops, and the like. Accordingly, it is desirable to monitor certain operating parameters and adjust the flow rates of the primary fuel 50, the fuel additive 52, and/or the diluent 56 in response to the monitored operating parameters.

As shown, a sensor 70 is disposed upstream of the fuel nozzle 32 and another sensor 72 is disposed within or downstream of the fuel nozzle 32. The sensors 70 and 72 monitor various operating conditions of the fuel supply system 11 and the fuel nozzle 32, such as pressure, flow rates, pressure differentials, flame temperature, flame length, flame volume, and the like. The sensors 70 and 72 are communicatively coupled to the controller 64, which may adjust the control valves 58, 60, and 62 based on the operating parameters detected by the sensors 70 and 72. For example, the controller 64 may determine that an operating parameter is not desirable and may execute instructions to adjust the control valves 58, 60, 62 in order to adjust the operating parameter toward a desired range.

In certain embodiments, the sensors 70 and 72 may detect a pressure drop or differential across a portion of the fuel nozzle 32. As noted earlier, the pressure differential may affect combustion dynamics, and thus, it is desirable to monitor and adjust the pressure differential. In a similar manner to adjusting the energy density of the fuel mixture 34, the pressure differential across the fuel nozzle 32 may be varied by changing the composition of the fuel mixture 34. Certain HHCs 52 have a greater heating value (i.e., energy per unit volume) than the primary fuel 50. Thus, the HHC 52 and the primary fuel 50 may be mixed in certain ratios to reduce the flow rate of the fuel mixture 34 while maintaining an approximately constant total heat output. Lower flow rates typically have lower pressure drops through orifices, and thus, adding HHCs 52 to the fuel mixture 34 may decrease the pressure drop across the fuel nozzle 32. Decreasing the pressure drop may be desirable, for example, to shift the heat release location and reduce combustion dynamics.

As noted earlier, changes in the operating conditions of the combustor 24 may result in combustion instabilities. Accordingly, it may be desirable to adjust the pressure differential across the fuel nozzle 32, while maintaining an approximately constant energy output. For example, a flow rate of the HHC 52 may be increased while a flow rate of the primary fuel 50 is decreased, such that the additional energy output contributed by the HHC 52 is substantially offset by the decreased energy output contributed by the primary fuel 50. In this manner, the resulting flow rate of the fuel mixture 34 is decreased and the density of the fuel mixture 34 is increased. As will be appreciated, the decreased flow rate may decrease the pressure drop across the fuel nozzle 32. The increased density may have a positive effect on flame location or shape. In summary, the composition and/or flow rate of the fuel mixture 34 may be changed to adjust the pressure differential across the fuel nozzle 32, while maintaining an approximately constant energy output.

The diluent 56 may be used in a similar manner to adjust the pressure differential across the fuel nozzle 32. That is, the flow rate of the diluent 56 may be increased and the flow rate of the primary fuel 50 may be decreased, such that the total energy output of the fuel mixture 34 remains the same. Certain diluents 56 have a lower energy density than the primary fuel 50. Thus, the diluents 56 and the primary fuel 50 may be mixed with various ratios to increase the flow rate of the fuel mixture 34 while maintaining an approximately constant total heat output. Higher flow rates typically have higher pressure drops through orifices, and thus, adding the diluents 56 to the fuel mixture 34 generally increases the pressure drop across the fuel nozzle 32. In certain configurations, the flow rate of the diluent 56 may be increased while the flow rate of the primary fuel 50 is decreased or remains the same. As a result, the energy density of the fuel mixture 34 is decreased. As will be appreciated, in such a configuration, the net effect on the pressure drop helps to mitigate the combustion dynamics. Accordingly, the addition of the diluent 56 may be designed to increase the pressure drop across the fuel nozzle 32, which may be desirable to improve the stability of the combustion flame.

The disclosed technique of holding one operating parameter constant while modifying another using the HHC 52, the diluent 56, or both, can be applied to various other operating parameters of the fuel nozzle 32. For example, the pressure, energy density, flow rate, pressure drop, pressure drop, flame length, flame volume, and the like may be held constant while another parameter is simultaneously varied. In addition, the aforementioned operating parameters are given by way of example and are not intended to be limiting. That is, it may be desirable to adjust the flow rates of the primary fuel 50, the HHC 52, the diluent 56, or any combination thereof to affect any other operating parameter related to combustion stability.

It should be noted that the fuel additive supply 52 and the diluent supply 56 may be used independently or in combination with each other. That is, certain embodiments of the fuel supply system 11 may include the fuel additive supply 52 but not the diluent supply 56. In addition, the use of the fuel additive supply 52 or the diluent supply 56 may be based on the orientation of the fuel nozzles 32 about the head end 44 (see FIG. 2). For example, the central fuel nozzle 48 may have a greater impact on combustion dynamics and may benefit more from addition of the fuel additive 52. On the other hand, it may be desirable to provide the outer fuel nozzles 44 with the diluent 56 in order to control the volume of the combustion flame.

It may be desirable to modify the fuel composition at different operating modes (e.g., startup, steady-state, partial load, full load, etc.) of the gas turbine system 10. For example, each operating mode may have a different ratio of the HHC 52 to the primary fuel 50. As will be appreciated, fuel gas compressors use a lower molecular weight fuel (e.g., the primary fuel 50) during start up. During partial load conditions, the HHC 52 may be slowly introduced in order to increase the molecular weight and heating value of the fuel mixture 34. At steady-state, the HHC 52 may be maintained in order to control the heating value of the mixture 34, as explained earlier. For example, the HHC 52 may be between approximately 0 to 30, 5 to 25, 10 to 20, or 12 to 18 percent of the total flow of the fuel mixture 34, depending on the operating mode of the gas turbine system 10. In addition, the percent of the HHC 52 may be the same or different between the fuel nozzles 32 (e.g., central fuel nozzle 48 and outer fuel nozzles 46)

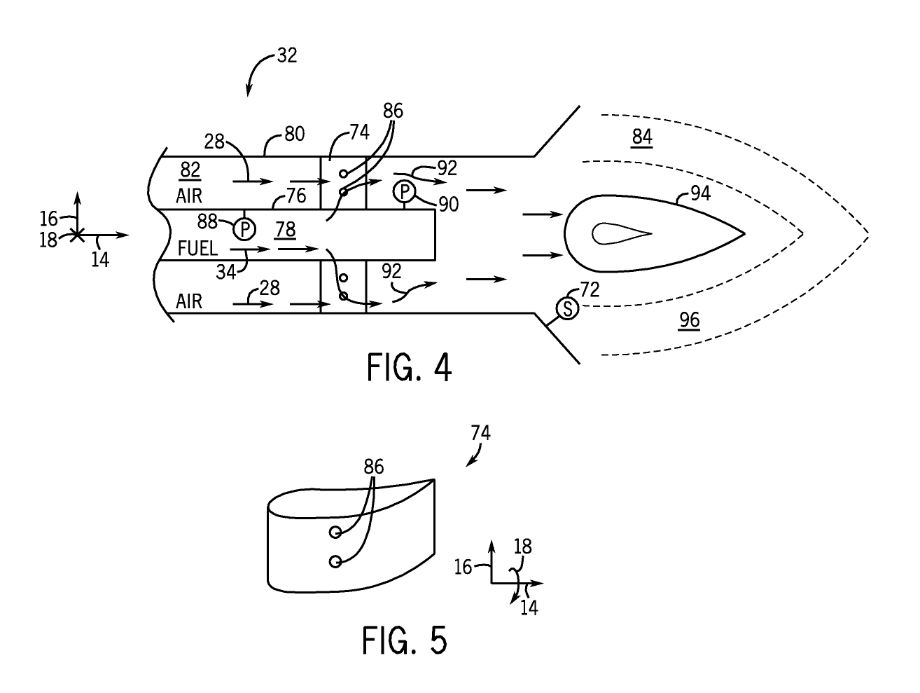

The configuration of the fuel nozzles 32 may also vary, as described below with respect to FIGS. 4-6. For example, FIG. 4 illustrates an embodiment of the fuel nozzle 32 with a plurality of swirl vanes 74 to mix the air 28 with the fuel mixture 34. As shown, the fuel nozzle 32 includes an inner wall 76 defining a central passage 78. Additionally, a shroud 80 surrounds the inner wall 76, thereby defining an annular passage 82.

During operation of the fuel nozzle 32, the air 28 flows through the annular passage 82 toward a combustion region 84. As illustrated, the fuel mixture 34 (e.g., primary fuel 50 and HHC 52) flows through the central passage 78 and enters the annular passage 82 through orifices 86 of the swirl vanes 74. For example, FIG. 5 is a perspective view of an embodiment of the swirl vane 74 having orifices 86. As noted earlier, the operability of the fuel nozzle 32 may be affected by the pressure drop of the fuel mixture 34 across the fuel nozzle 32. For example, the stability of the combustion flame may be affected by the pressure drop of the fuel mixture 34 across the orifices 86. Turning back to FIG. 4, sensors 88 and 90 are disposed within the fuel nozzle 32 to detect the pressure drop across the orifices 86. In certain embodiments, the sensor 90 measure pressure detects fluctuations caused by the combustion of the fuel mixture 34 and the air 28. The sensors 88 and 90 are communicatively coupled to the controller 64 of FIG. 3, which may adjust the control valves 58, 60, and 62 in response to the pressure drop detected by the sensors 88 and 90. For example, the pressure fluctuations may be used to determine respective flow rates of the HHC 52 and/or the diluent 56.

A mixture 92 of the air 28 and the fuel 34 flows to the combustion region 84, where the mixture 92 combusts, forming a combustion flame 94. As shown, the combustion flame 94 occupies a volume 96, which may be adjusted by adding the HHC 52 or the diluent 56 to the primary fuel 50, as explained in detail above.

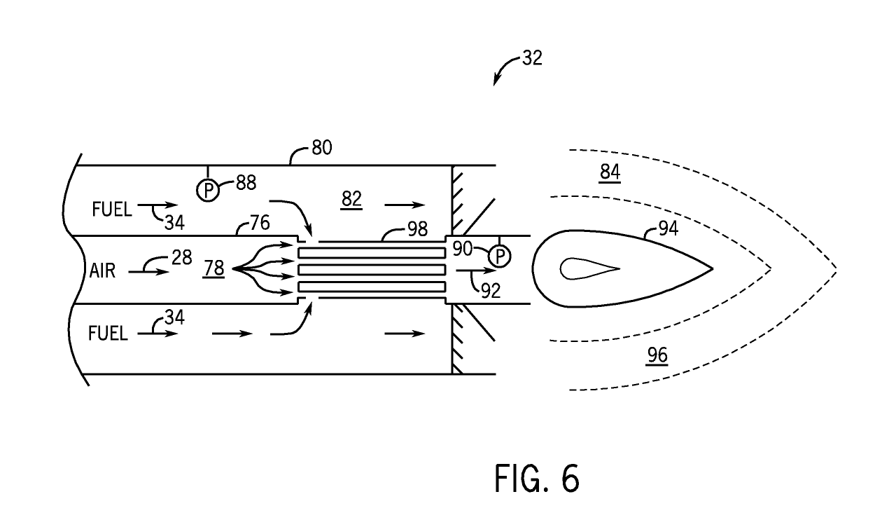

FIG. 6 illustrates another embodiment of the fuel nozzle 32 with a plurality of pilot tubes 98 to mix the air 28 with the fuel mixture 34 (e.g., primary fuel 50 and HHC 52). During operation of the fuel nozzle 32, the air 28 flows through the central passage 78 and axially 14 into the plurality of pilot tubes 98. The fuel mixture 34 flows through the annular passage 82 and radially 16 into the pilot tubes 98. In certain embodiments, the fuel 34 may be supplied through one or more feed tubes. The air 28 and the fuel 34 mix within the pilot tubes 98, and the mixture 92 of air 28 and fuel 34 is subsequently directed into the combustion region 84. However, it should be noted that a variety of other configurations of fuel nozzles 32 with varying flow paths for the air 28 and the fuel 34 may be used. The sensors 88 and 90 are disposed within the annular passage 82 and the central passage 78, respectively. The sensor 88 measures an upstream pressure of the fuel 34 (e.g., upstream of the pilot tubes 98), whereas the sensor 90 measures a downstream pressure of the fuel 34 (e.g., downstream of the pilot tubes). In certain embodiments, it may be desirable to adjust the composition of the fuel mixture 34 to improve the stability of the flame 94 based on the pressures detected by the sensors 88 and 90. As explained earlier, the composition of the fuel 34 may be controlled by adjusting the control valves 58, 60, and 62, which in turn are controlled by the controller 64.

It should be noted that the embodiments of the fuel nozzles 32 and their respective geometries are not intended to be limiting. For example, the fuel mixture 34 may flow through the central passage 78 and air may flow through the annular passage 82 and vice versa. Indeed, the disclosed techniques may be applied to a variety of fuel nozzle designs, all of which fall within the scope and spirit of the present disclosure.

Technical effects of the disclosed embodiments include the use of the HHC 52 to adjust a fuel composition of the fuel mixture 34. The composition of the fuel mixture 34 is varied in order to adjust certain properties (e.g., energy density or heating value) of the fuel 34, which, in turn, adjusts the pressure, temperature, length, volume, or another parameter of the combustion flame 94. The HHC 52 has a higher molecular weight, density, and/or energy density than the primary fuel 50, which enables various properties of the fuel mixture 34 to be adjusted. In particular, the energy density of the fuel mixture 34 may be adjusted while maintaining an approximately constant heat input to the combustor 24 by varying the flow rate of the HHC 52 and/or the diluents 56. Additionally or alternatively, the pressure drop across the fuel nozzle 32 may be adjusted while maintaining an approximately constant energy output. These adjustments improve the stability of the combustion flame 94, and subsequently, improve the efficiency and operability of the gas turbine system 10.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system, comprising:
a fuel supply system, comprising:
a primary fuel supply configured to deliver a primary fuel comprising substantially methane and having a first average molecular weight;
a fuel additive supply configured to deliver a fuel additive having a second average molecular weight that is greater than the first average molecular weight;
a common pipeline coupled to the primary fuel supply and the fuel additive supply and configured to direct a mixture of the primary fuel and the fuel additive into a fuel nozzle; and
a controller configured to control a ratio of the primary fuel to the fuel additive based on an operating mode of the fuel nozzle.

2. The system of claim 1, wherein the primary fuel and the fuel additive each comprise one or more hydrocarbons, the primary fuel comprises a first average number of carbon atoms per molecule, the fuel additive comprises a second average number of carbon atoms per molecule, and the second average number is at least two greater than the first average number.

3. The system of claim 1, comprising the fuel nozzle configured to receive the mixture of the primary fuel and the fuel additive.

4. The system of claim 3, wherein the fuel nozzle comprises a plurality of pilot tubes or a plurality of swirl vanes configured to mix the primary fuel, the fuel additive, and air.

5. The system of claim 3, comprising:
a sensor configured to detect an operating parameter related to combustion of the mixture of the primary fuel and the fuel additive; and
a control valve disposed along a flow path of the fuel additive, wherein the controller is configured to adjust the control valve based on the operating parameter detected by the sensor to control the ratio of the primary fuel to the fuel additive.

6. The system of claim 5, wherein the operating parameter comprises a pressure, a temperature, a flow rate, a pressure drop, a flame length, a flame color, or any combination thereof.

7. The system of claim 1, wherein the primary fuel comprises a first volumetric heating value and the fuel additive comprises a second volumetric heating value that is greater than the first volumetric heating value.

8. The system of claim 7, comprising a diluent supply coupled to the common pipeline and comprising a diluent having a third volumetric heating value that is less than the first volumetric heating value.

9. The system of claim 8, comprising:
a sensor configured to detect a pressure drop across a portion of the fuel nozzle;
a first control valve disposed along a first flow path of the fuel additive;
a second control valve disposed along a second flow path of the diluent; and
a controller configured to adjust the pressure drop by adjusting a flow rate of the fuel additive or the diluent.

10. A gas turbine system, comprising:
a compressor configured to compress air;
a combustor comprising at least one fuel nozzle, wherein the combustor is configured to receive the air from the compressor and to combust the air and a fuel mixture to generate combustion products;
a fuel supply system configured to supply the fuel mixture to the at least one fuel nozzle, comprising:
a primary fuel supply comprising the primary fuel having a first average volumetric heating value;
a fuel additive supply comprising the fuel additive having a second average volumetric heating value that is greater than the first average volumetric heating value;
a common pipeline coupled to the primary fuel supply and the fuel additive supply and configured to mix the primary fuel and the fuel additive to form the fuel mixture and direct the fuel mixture to a pilot fuel nozzle of the combustor;
a controller configured to control a ratio of the primary fuel to the fuel additive based on an operating mode of the combustor, wherein the operating mode comprises a start-up mode, a steady-state mode, or both; and
a turbine configured to receive the combustion products from the combustor.

11. The system of claim 10, comprising:
a sensor configured to detect an operating parameter related to combustion of the air and the fuel mixture;
a first control valve disposed along a fuel flow path of the primary fuel; and
a second control valve disposed along a fuel additive flow path of the fuel additive, wherein the controller is configured to adjust a fuel flow rate of the primary fuel, a fuel additive flow rate of the fuel additive, or both, based on the operating parameter detected by the sensor to control the ratio of the primary fuel to the fuel additive.

12. The system of claim 11, wherein the operating parameter comprises a pressure, a temperature, a flow rate, a pressure drop, a flame length, a flame color, or any combination thereof.

13. The system of claim 11, wherein the primary fuel comprises a first average molecular weight, and the fuel additive comprises a second average molecular weight that is greater than the first average molecular weight.

14. The system of claim 11, wherein the operating parameter comprises a pressure drop across an orifice of a swirl vane of the fuel nozzle.

15. The system of claim 14, wherein the fuel mixture comprises an overall volumetric heating value, and wherein the controller is configured to control the pressure drop across the orifice while maintaining the overall volumetric heating value approximately constant.

16. A method, comprising;
detecting first and second operating parameters related to combustion of air and a fuel mixture within a combustor, wherein the fuel mixture comprises a primary fuel and a fuel additive having a first volumetric heating value that is greater than an overall volumetric heating value of the fuel mixture;
determining if the first operating parameter is desirable using a sensor and a controller; and
adjusting the first operating parameter while maintaining the second operating parameter approximately constant when the first operating parameter is not desirable.

17. The method of claim 16, wherein the first and second operating parameters each comprise a pressure, a temperature, a flow rate, a pressure drop, a flame length, a flame color, or any combination thereof.

18. The method of claim 16, wherein adjusting the first operating parameter while maintaining the second operating parameter approximately constant is based on an operating mode of a gas turbine system.

19. The method of claim 16, comprising adjusting an additional flow rate of the primary fuel based on the measurement of the operating parameter.

20. The method of claim 16, wherein the flow rate of the fuel additive is less than 30 percent of a flow rate of the fuel mixture.
